(19) United States
(12) Patent Application Publication
(10) Pub. No.: US 2025/0292179 A1
(43) Pub. Date: Sep. 18, 2025

(54) COMPUTER IMPLEMENTED METHOD AND SYSTEM FOR OPTIMIZING AND PROTECTING BUSINESS HEALTH IN REAL-TIME USING ARTIFICIAL INTELLIGENCE

(71) Applicant: Profitops Inc., Cumming, GA (US)

(72) Inventor: Shravan Talupula, Cumming, GA (US)

(73) Assignee: Profitops Inc., Cumming, GA (US)

(21) Appl. No.: 18/607,402

(22) Filed: Mar. 15, 2024

(51) Int. Cl. G06Q 10/0637; G06Q 10/0635; G06Q 10/0639

(52) U.S. Cl. CPC G06Q 10/06375; G06Q 10/0635; G06Q 10/06393

(57) ABSTRACT

A computer-implemented system and method may acquire historical and real-time data via a plurality of plug-ins of an adaptor module. Further, the system and method may organize and standardize the acquired historical and real-time data in a data center. Further, the system and method may analyze the organized and standardized historical and real-time data stored in the data center. Further, the system and method may develop a mathematical model in real time based on the analysis of the historical and real-time data in the data center. Further, the system and method may track and optimize the BHI of the business in real time by applying an optimization algorithm of a business optimization module to the developed mathematical model. Furthermore, the system and method may present notification to a user/business on an interface in form of signals, events, noises and actions.

### FIELD OF THE DISCLOSURE

The present disclosure relates to a method and system for optimizing business health index (BHI), and, more particularly, a method and system for optimizing business health index (BHI) in real-time using artificial intelligence.

### BACKGROUND OF THE DISCLOSURE

Understanding and enhancing Business Health and Optimization represents a pivotal facet in navigating the intricate terrain of modern enterprises. The vitality and sustained success of any business hinge upon its adaptability, resilience, and optimized operational performance within a constantly evolving marketplace. Business health encapsulates a multifaceted spectrum encompassing financial stability, operational efficiency, market competitiveness, and adaptive strategies. The pursuit of optimal business health involves a dynamic interplay between various factors, including but not limited to, revenue generation, cost management, customer satisfaction, innovation, and risk mitigation.

Traditional approaches to assessing business health often grapple with limitations, relying on static drivers/metrics or periodic evaluations that might not capture the nuanced dynamics of contemporary markets. These methods might overlook emerging trends, fail to offer real-time insights, or lack the agility to adapt swiftly to changing environments, leaving businesses vulnerable to unforeseen challenges. Optimizing business health demands a paradigm shift towards innovative methodologies that fuse cutting-edge technologies, data-driven insights, and adaptable frameworks. The integration of advanced analytics, artificial intelligence that includes but not limited to machine learning, predictive modeling, prescriptive modeling and causal inference heralds a new era in fortifying and optimizing business health.

Accordingly, there exists a need for such a system and method that may not only use historical data to optimize the business health. Further, there may be a need for such a system and method that may not follow conventional strategy, technology and perspective. Accordingly, there exists a need for such a system and method that may have real-time analytics that may include continuous monitoring and analysis of diverse business drivers/metrics in real-time, providing a comprehensive and up-to-date snapshot of the business's health status.

Accordingly, there exists a need for such a system and method that may have causal inference which is pivotal in understanding the impact of various factors on business outcomes. It moves beyond mere correlation, offering deeper insights into the cause-and-effect relationships that drive business health. Accordingly, there exists a need for such a system and method that may have holistic perspective which may include moving beyond conventional siloed assessments, this approach aims to consider interconnected aspects of the business, facilitating a holistic understanding of its health.

Accordingly, there exists a need for such a system and method that may have adaptive strategies which may include utilization of predictive algorithms to anticipate market shifts, identify potential risks, and dynamically adapt strategies to maintain resilience and seize opportunities. Accordingly, there exists a need for such a system and method that may have proactive decision-making that may empower stakeholders with actionable insights derived from data-driven analyses, fostering informed decision-making to optimize business health and performance.

Accordingly, there exists a need for such a system and method that may have risk mitigation for identifying vulnerabilities and implementing proactive measures to mitigate risks, ensuring the sustained viability and longevity of the business. Accordingly, there exists a need for such a system and method that may have sustainability and environmental impact that may consider the growing emphasis on sustainable practices, it's crucial to integrate environmental impact assessments into the business health evaluation. This includes measuring and optimizing the company's carbon footprint, resource utilization, and overall ecological impact.

The evolution towards optimizing business health and performance is poised to redefine the operational landscape, transcending the limitations of conventional methodologies. By harnessing the power of cutting-edge technologies and data-driven insights, this approach endeavors to not only enhance the current health of enterprises but also pave the way for sustained growth, adaptability, and competitiveness in a dynamic business ecosystem.

### SUMMARY OF THE DISCLOSURE

In view of the foregoing disadvantages inherent in the prior art, the general purpose of the present disclosure is to provide a system and method for optimizing business health index (BHI) in real-time using artificial intelligence to include all advantages of the prior art, and to overcome the drawbacks inherent in the prior art.

An object of the present disclosure is to provide a system and method that may not only use historical data to optimize the business health.

Another object of the present disclosure is to provide a system and method that may not follow conventional strategy, technology and perspective.

In view of the above objects, in one aspect, a computer-implemented method (100) for computing, monitoring, optimizing and protecting business health of a business in real-time is provided. The business health may be evaluated in index form herein referred in as business health index (BHI). The computer-implemented method may include receiving/acquiring historical and real-time data, organizing the acquired historical and real-time data in a data center, standardizing the acquired historical and real-time data in the data center, analyzing the organized and standardized historical and real-time data in the data center, identifying drivers for the business by detecting cause-and-effect relationships, developing a mathematical model in real-time based on the analysis of the historical and real-time data and the identified drivers, tracking and optimizing the BHI of the business in real-time by applying an optimization algorithm to the developed mathematical model, perform root cause analysis to identify underlying causes that influence the business and presenting notification to a user/business on an interface in form of signals, events, noises and actions. The computer-implemented method uses an artificial intelligence module to organize the acquired data, analyze the organized data, standardize the acquired data, develop a mathematical model, optimize and protect the BHI of the business.

In one embodiment of the present disclosure, the mathematical model of the computer-implemented method may include an equation having plurality of direct and nested industry specific performance drivers/metrics with a static/dynamic driver/metric weight.

In one embodiment of the present disclosure, the computer-implemented method may forecast each performance driver/metric involved in business by utilizing historical and real-time data.

In one embodiment of the present disclosure, the computer-implemented method presents users with contextual information regarding events occurring within the business. This is achieved by utilizing domain knowledge in addition to the historical and real-time data in the form of a causal graph, which assists users in performing root cause analysis.

In one embodiment of the present disclosure, the computer-implemented method may automate future steps of the business based on past user actions aimed at improving the performance drivers/metrics to optimize the BHI of the business.

In one embodiment of the present disclosure, the computer-implemented method may forecast opportunities, risks, and threats of the business by analyzing past incidents to avoid repeat mistakes and present informed decisions to the business to optimize the BHI of the business.

In one embodiment of the present disclosure, the computer-implemented method may integrate external knowledge comprising industry benchmarks and aggregated actions across various industries, business units, and geographical locations to optimize the BHI of the business.

In one embodiment of the present disclosure, the computer-implemented method may integrate cross-organizational learning capabilities, detect patterns and devise accurate, actionable strategies based on collective organizational experiences to optimize the BHI of the business.

In one embodiment of the present disclosure, the computer-implemented method may suggest and assign tasks based on identified business opportunities, risks, or threats, with an automated follow-up mechanism to ensure task completion and track individual performance for accountability and rewards.

In one embodiment of the present disclosure, the computer-implemented method employs an edge computing client agent to identify, recommend rectifications for, and proactively perform actions to prevent data entry errors at the source to minimize mistakes and inefficiencies to guide actions that could adversely affect business outcomes.

In one embodiment of the present disclosure, the computer-implemented method may facilitate internal and external industry benchmark comparisons.

In yet another aspect of the present disclosure, a computer-implemented system to compute, monitor, optimize and protect business health of a business in real-time is provided. The business health may be evaluated in index form herein referred in as business health index (BHI). The computer-implemented system may include an adaptor module, a data center, a business optimization module and an artificial intelligence module. The adaptor module may be configured in a computing device, to configure a plurality of plug-ins to acquire historical and real-time data. Further, the data center may store the acquired historical and real-time data and the business optimization module may have an optimization algorithm. Furthermore, the artificial intelligence module may organize the acquired historical and real-time data, standardize the historical and real-time data, analyse the organized and standardized data, develop a mathematical model and optimize the BHI of the business.

In one embodiment of the present disclosure, the computer-implemented system may include a client agent to identify and recommend rectification and perform actions to prevent data entry errors at the source and prevent mistakes and inefficiencies. The client agent may advise against actions that may negatively impact business outcomes.

In one embodiment of the present disclosure, the computer-implemented system includes a suite of interfaces that enable users to define or edit causal relationships, either by starting from scratch or by using pre-designed templates, facilitated through a specialized graph editor, which is tailored to accommodate the specific needs and scenarios of the business, thereby simplifying the process of customizing causal relationships to optimize the business health index.

In one embodiment of the present disclosure, the computer-implemented system may include a set of interfaces enabling a user to define and utilize industry-specific drivers/metrics with a static/dynamic driver/metric weight.

In one embodiment of the present disclosure, the mathematical model developed by the computer-implemented system may include an equation having plurality of direct and nested industry specific performance drivers/metrics with the static/dynamic driver/metric weight.

In one embodiment of the present disclosure, the computer-implemented system may forecast each performance driver/metric involved in business by utilizing historical and real-time data.

In one embodiment of the present disclosure, the computer-implemented system may automate future steps of the business based on past user actions aimed at improving the performance drivers/metrics to optimize the BHI of the business.

In one embodiment of the present disclosure, the computer-implemented system may forecast opportunities, risks, and threats of the business by analyzing past incidents to avoid repeat mistakes and present informed decisions to the business to optimize the BHI of the business.

In one embodiment of the present disclosure, the computer-implemented system may integrate external knowledge comprising industry benchmarks and aggregated actions across various industries, business units, and geographical locations to optimize the BHI of the business.

In one embodiment of the present disclosure, the computer-implemented system may integrate cross-organizational learning capabilities, detect patterns and devise accurate, actionable strategies based on collective organizational experiences to optimize the BHI of the business.

In one embodiment of the present disclosure, the computer-implemented system may suggest and assign tasks based on identified business opportunities, risks, or threats, with an automated follow-up mechanism to ensure task completion and track individual performance for accountability and rewards.

In one embodiment of the present disclosure, the computer-implemented system utilizes an edge computing client agent to identify and rectify data entry errors at their source. This proactive approach not only prevents mistakes and inefficiencies but also advises against actions that could negatively impact business outcomes.

In one embodiment of the present disclosure, the computer-implemented system may facilitate industry benchmark comparisons.

In yet another aspect of the present disclosure, a computer program product embodied on a non-transitory computer readable medium, and that, when executed by a processor, cause a system to receive/acquire historical and real-time data, organize the acquired historical and real-time data in a data center, standardize the acquired historical and real-time data in the data center, analyze the organized and standardized historical and real-time data in the data center, identify drivers for the business by detecting cause-and-effect relationships, develop a mathematical model in real-time based on the analysis of the historical and real-time data and the identified drivers, track and optimize the BHI of the business in real-time by applying an optimization algorithm to the developed mathematical model, perform root cause analysis to identify underlying causes that influence the business and presenting notification to a user/business on an interface in form of signals, events, noises and actions.

This together with the other aspects of the present disclosure, along with the various features of novelty that characterize the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description taken in conjunction with the accompanying drawings, in which:

FIG. 1 illustrates an exemplary environment in which various exemplary implementations of the disclosed teachings may be practiced;

FIG. 2 is a flowchart illustrating a method for computing, monitoring, optimizing and protecting business health index (BHI) of a business in real-time using artificial intelligence, in accordance with an exemplary embodiment of the present disclosure;

FIG. 3 is a flowchart illustrating a method for receiving/acquiring historical and real-time data in accordance with an exemplary embodiment of the present disclosure;

FIG. 4 is a block diagram illustrating organizing the acquired historical and real-time data in a data center in a method in accordance with an exemplary embodiment of the present disclosure;

FIGS. 5(a) and 5(b) is a block diagram illustrating standardization of the acquired historical and real-time data in the data center in a method, in accordance with an exemplary embodiment of the present disclosure;

FIGS. 6(a) and 6(b) is a block diagram illustrating identification of drivers/metrics for the business and a driver/metric causal graph in a method, respectively, in accordance with an exemplary embodiment of the present disclosure;

FIG. 7 is a table illustrating drivers/metrics used in model development in a method, in accordance with an exemplary embodiment of the present disclosure;

FIG. 8(a) and FIG. 8(b) illustrates a business optimization module in accordance with an exemplary embodiment of the present disclosure;

FIG. 9, a diagram for performing root cause analysis to identify underlying causes that influence the business in a method 100 is shown, in accordance with an exemplary embodiment of the present disclosure;

FIGS. 10(a), (b), (c) and (d) illustrate presentation of notifications to a user/business on an interface in a method, in accordance with an exemplary embodiment of the present disclosure; and

FIG. 11, illustrates a block diagram of a computer-implemented system 200 to compute, monitor, optimize and protect business health of a business in real-time in a method in accordance with an exemplary embodiment of the present disclosure;

Like reference numerals refer to like parts throughout the description of several views of the drawing.

### DESCRIPTION OF THE DISCLOSURE

The exemplary embodiments described herein detail for illustrative purposes are subject to many variations in implementation. The present disclosure provides a computer-implemented method 100 and a system 200 for computing, monitoring, optimizing and protecting business health of a business in real-time. It should be emphasized, however, that the present disclosure is not limited to a computer-implemented method 100 for computing, monitoring, optimizing and protecting business health of a business in real-time. The present invention has been described considering that the system is a plug-in, but should not be considered limited to a plug-in only. It is understood that various omissions and substitutions of equivalents are contemplated as circumstances may suggest or render expedient, but these are intended to cover the application or implementation without departing from the spirit or scope of the present disclosure.

The terms “a” and “an” herein do not denote a limitation of quantity, but rather denote the presence of at least one of the referenced items.

The terms “having”, “comprising”, “including”, and variations thereof signify the presence of a component.

The disclosure provides a computer-implemented method 100 for computing, monitoring, optimizing and protecting business health of a business in real-time. The business health may be evaluated in index form herein referred in as business health index (BHI). The computer-implemented method may use an artificial intelligence module to organize the acquired data, analyze the organized data, standardize the acquired data, develop a mathematical model, optimize and protect the BHI of the business.

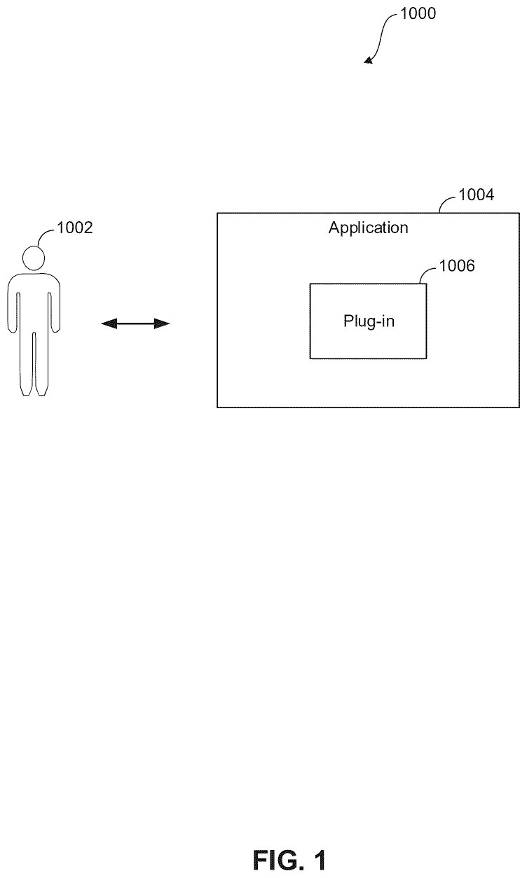

A computer-implemented method 100 will now be explained in conjunction with FIGS. 1-11 as below, in accordance with various exemplary embodiments of the present disclosure. Without departing from the scope of the present disclosure, the drawings as shown herein are only for better understanding of the disclosure and may not be in anyway considered to be limiting only to the diagrams as disclosed herein. There may be various other arrangement/configurations that may be covered by the claims of the present disclosure. A person skilled in the art will appreciate that the method and system can be implemented in other ways, such as the features and capability may be pre-programmed within the business application or business control unit. It may be hard wired into the business application or business control unit itself by anyone who acquires the rights to use the methodology of the present invention. Computing, monitoring, optimizing and protecting business health is performed based on one or more pre-defined algorithms. The pre-defined algorithms described herein may include various algorithms applied to perform various steps for computing, monitoring, optimizing and protecting business health that have been described in detail in conjunction with the description of the accompanying drawings. Accordingly, the pre-defined algorithms may vary with the scopes of computing, monitoring, optimizing and protecting business health.

Referring now to FIG. 1 illustrates an exemplary environment 1000 in which various embodiments of the present invention may be practiced. An environment 1000, as shown in FIG. 1, includes a user/business 1002, a business application/business control unit 1004, and a plug-in 1006. User/business 1002 uses a Data Processing Unit (DPU, not shown in the figure) to access application 1004. Examples of the DPU described herein include, but are not limited to, a personal computer, a laptop, a personal digital assistant (PDA), a smart phone, a mobile computing device, and the like. Further, the various types of business application/business control unit 1004 can be, but are not limited to ERP, MRP, PIM, CDP, TMS, WMS, CRM, EPM, YMS, POS, Revenue Growth Management Systems, Reservation systems, Marketing automation platforms, SEO tools, CRO tools. Further, plug-in 1006 is integrated with business application/business control unit 1004 to facilitate computing, monitoring, optimizing and protecting business health of a business in real-time in a business application/business control unit 1004. Plug-in 1006 also facilitates creation of folders and indexes, and identification of commercial e-mails and the like.

Further, plug-in 1006, as described above, may correspond to an add-on, add-in, toolbar, and the like. In one exemplary implementation of the disclosed teachings, plug-in 1006 may be embodied in the form of software. In another exemplary implementation of the disclosed teachings, plug-in 1006 may be embodied in the form of hardware. In yet another exemplary implementation of the disclosed teachings, plug-in 1006 may be embodied in the form of a combination of hardware and software.

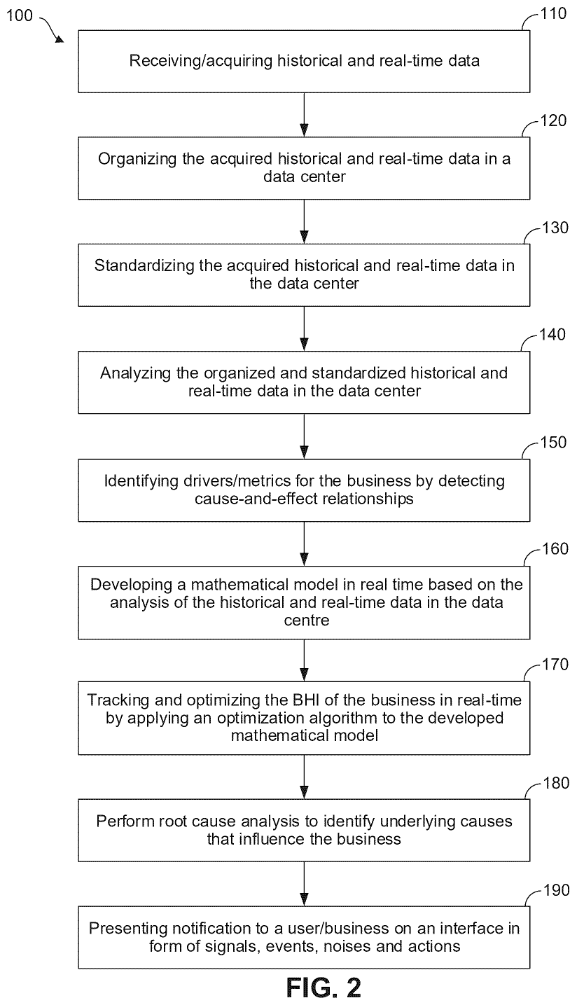

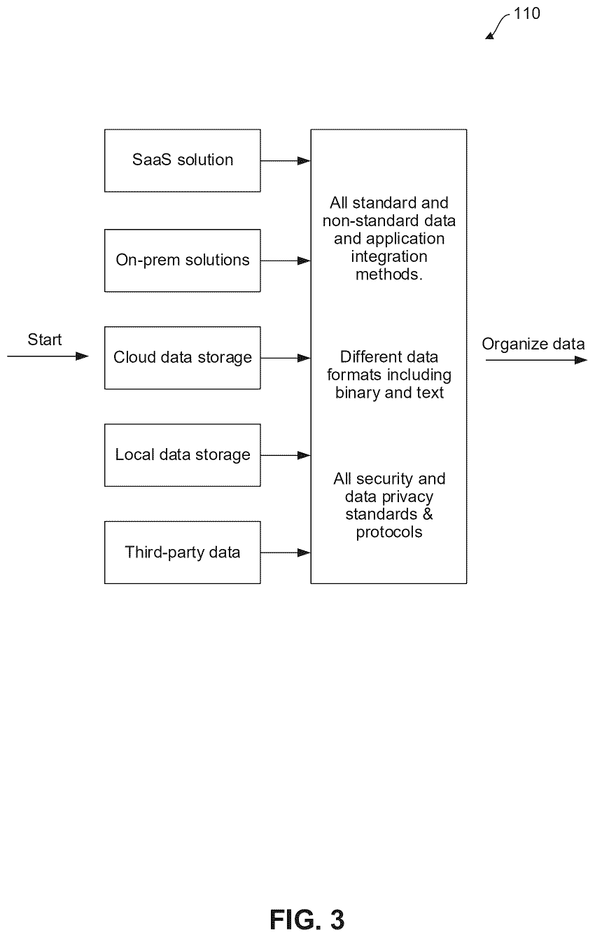

Referring now to FIG. 2, a flowchart illustrating a method for computing, monitoring, optimizing and protecting business health index (BHI) of a business in real-time using artificial intelligence is shown, in accordance with an exemplary embodiment of the present disclosure. The business health may be evaluated in index form herein referred in as business health index (BHI). FIG. 2 will now be explained in conjunction with FIG. 1. As shown in FIG. 2, the computer-implemented method may include a step 110 for receiving/acquiring data. The data may be historical and/or real-time acquired from different sources which is discussed later in the description of FIG. 3. At step 120, the method 100 organizes the acquired historical and real-time data in a data center 240 using an artificial intelligence module 260 which is discussed later in the description of FIG. 3. Further, at step 130, the method 100 standardizes the acquired historical and real-time data in the data center 240 using the artificial intelligence module 260.

At step 140, the method 100 may analyze the organized and standardized historical and real-time data in the data center 240 using the artificial intelligence module 260. Furthermore, at step 150, the method 100 may identify drivers/metrics for the business by detecting cause-and-effect relationships. Furthermore, at step 160, the method 100 may develop a mathematical model in real-time using the artificial intelligence module 260, based on the analysis of the historical and real-time data in the data center 240. The method 100 at step 170 may track and optimize the BHI of the business in real-time by applying an optimization algorithm to the developed mathematical model. At step 170 the method 100 may track and optimize the BHI of the business in real-time to achieve the desired or pre-defined BHI as per industry standards and benchmark. Furthermore, at step 180, the method 100 may perform root cause analysis to identify underlying causes that influence the business. In one embodiment, at step 190 the method 100 may present notifications to a user/business on an interface in form of signals, events, noises and actions. The objective to present the notifications at step 190 is to optimize the BHI at discussed in step 170. In one embodiment of the disclosure, the steps may be performed in sequence, however, without departing from the scope of the present invention the certain steps may be performed anytime without following the sequential order. For example, the step 180 in the method 100 performing root cause analysis to identify underlying causes that influence the business may be performed anytime as and when required, manually or via the artificial intelligence module 260.

Referring now to FIG. 3, a block diagram illustrating a method for receiving/acquiring (step 110) historical and real-time data is shown, in accordance with an exemplary embodiment of the present disclosure. FIG. 3 will now be explained in conjunction with FIGS. 1 and 2. As shown in FIG. 3, the historical and real-time data may be acquired from different sources such as SaaS solution, On-prem solution and the like. Further, historical and real-time data may be acquired from different storage source such as cloud data storage, local data storage, third party data storage and the like. The data acquired from different sources may be standard data like database records, flatfiles, spreadsheets, API responses (XML, JSON etc.) and non-standard data like text documents, emails, web pages, log files, etc. Further, the data acquired from different sources may be in different formats including binary and texts, for example, PDFs, images, videos, audio recordings like CSR calls. Furthermore, all security and data privacy standards and protocols like ISO/IEC 27001, GDPR (General Data Protection Regulation), HIPAA (Health Insurance Portability and Accountability Act), PCI-DSS (Payment Card Industry Data Security Standard), SOC 2 (Service Organization Control 2), CCPA (California Consumer Privacy Act), NIST Framework, FERPA (Family Educational Rights and Privacy Act), GLBA (Gramm-Leach-Bliley Act), PSD2 (Revised Payment Service Directive), PIPEDA (Personal Information Protection and Electronic Documents Act), COPPA (Children's Online Privacy Protection Act), FIPS (Federal Information Processing Standards), OWASP (Open Web Application Security Project) standards, SAML (Security Assertion Markup Language), OAuth, OpenID Connect, TLS (Transport Layer Security), SSH (Secure Shell), PGP (Pretty Good Privacy). Thereafter, the method 100 moves to step 120 to organize the acquired historical and real-time data in a data center 240 using an artificial intelligence module 260.

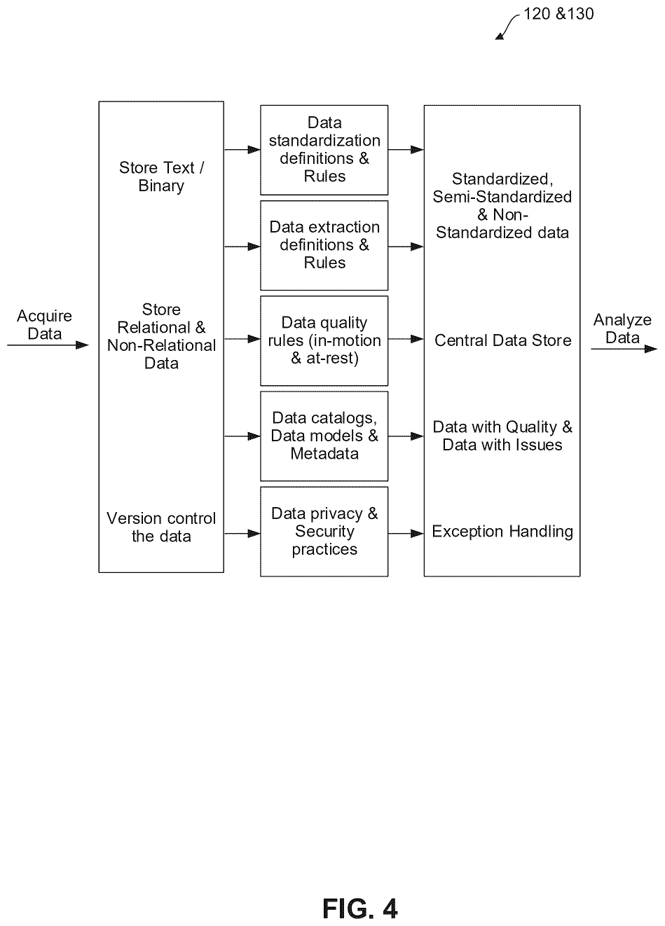

Referring now to FIG. 4, a block diagram illustrating organizing the acquired historical and real-time data in a data center in the method 100 is shown, in accordance with an exemplary embodiment of the present disclosure. FIG. 4 will now be explained in conjunction with FIGS. 1 to 3. As shown in FIG. 4, the acquired historical and real-time data may be arranged in their pre-defined categories.

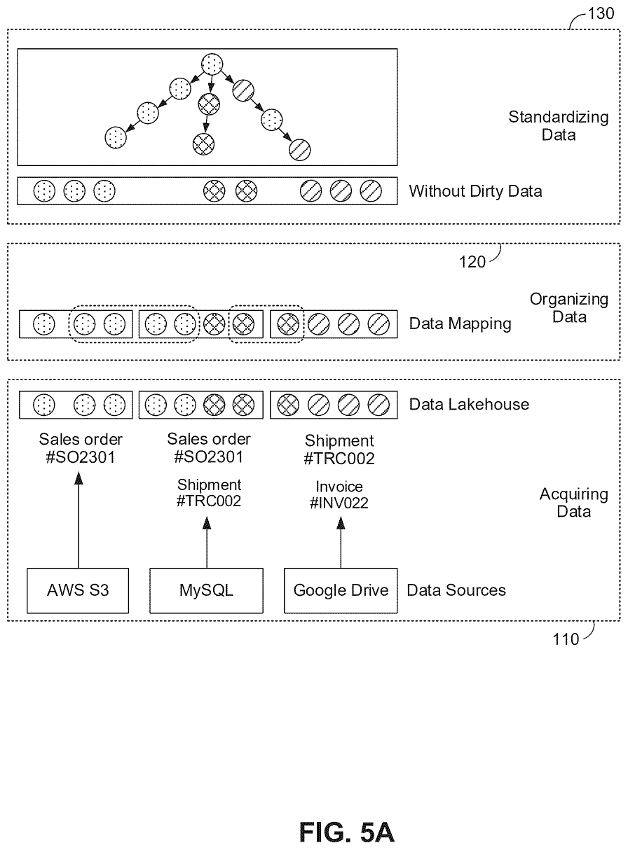

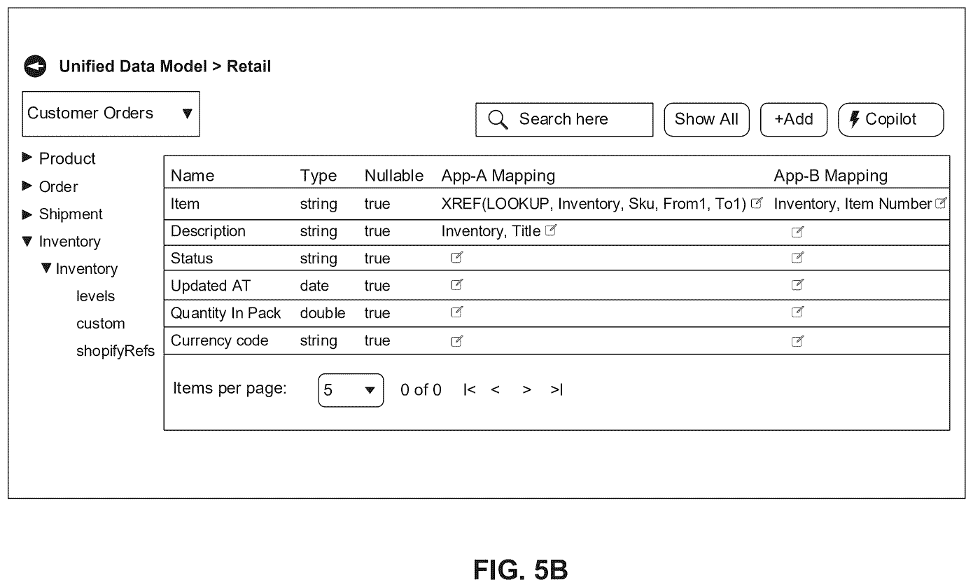

Referring now to FIGS. 5(a), 5(b) and 5(c), a block diagram illustrating standardization of the acquired historical and real-time data in the data center in the method 100 is shown, in accordance with an exemplary embodiment of the present disclosure. FIGS. 5(a), 5(b) and 5(c) will now be explained in conjunction with FIGS. 1 to 4. As shown in FIG. 5(a), in addition to organizing the acquired historical and real-time data in the step 120, the method may further standardize the acquired historical and real-time data at step 130. At step 130 of standardization, the data may be filtered so as to avoid data redundancy, alienating the unwanted/dirty data and further structure, tabulate and/or categorize/classify the filtered data, as shown in FIG. 5(a). In one exemplary embodiment, at step 130 of standardization, different codification used for the same purpose/thing may be identified and further aligned in the same category i.e. implementing standardization of Product Identification Codes like SKU (Stock Keeping Unit), UPCs (Universal Product Codes) or EANs (European Article Numbers) for products to ensure consistent tracking and identification across different systems and stores in a small business, as shown in FIG. 5(b). However, without departing from the scope of the present disclosure, different types of data may be standardized, for example Customer Data Normalization, Date Formatting, Currency and Pricing Formats, Size and Measurement Units, Inventory Categorization, Payment Method Classification, Sales Data Structure, Loyalty Program Data, Online and Offline Data Integration and the like.

In one embodiment, at step 130 of standardization, the method 100 may standardize data from the different format such as JSON, XML, CSV and the like.

In one embodiment, the method 100 may use a unified model approach which may include a common data model which may enforce a common language for standardization, and may simplify the AI model development and makes the AI models agnostic to a business environment. This may accelerate the AI model deployments. For example, as shown in below, irrespective of the number of clients (Client 1, Client 2, etc.) and respective product codes for those clients (A, B, etc.), the unified model approach may use the common language (C) for the product codes instead of A, B, etc. This may simplify the AI model development and makes the AI models agnostic to a business environment.

| Client 1 | Client 2 |
|---|---|
| A = ERP1.Product | A = ERP2.Product |
| B = CRM1.Customer | B = CRM2.Customer |

C.Product = A
C.Customer = B
AI Model (Ex: Price elasticity) - C.Product.Price, C.Customer.Name

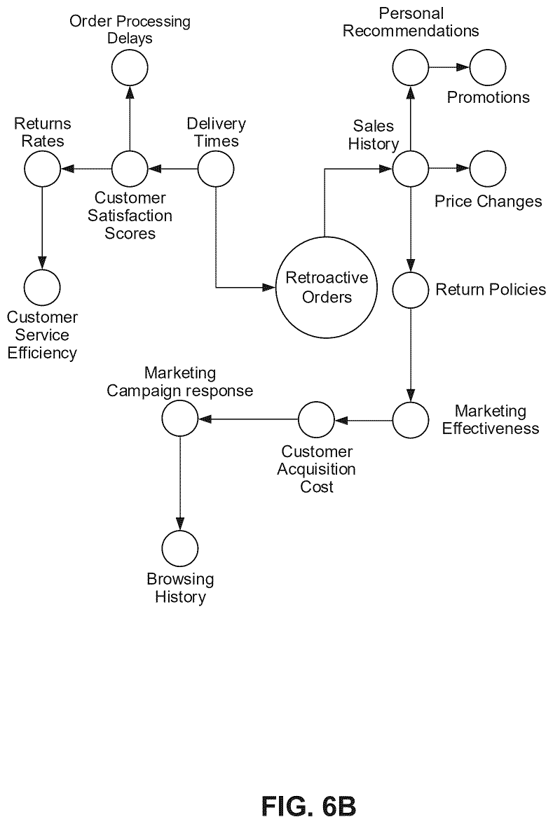

Referring now to FIGS. 6(a) and 6(b), illustrating is a block diagram for identification of drivers/metrics for the business and a driver/metric graph in a method, respectively. FIGS. 6(a) and 6(b) will now be explained in conjunction with FIGS. 1 to 5(b). After acquiring, organizing and standardizing the historical and real-time data in the data center, the method 100, at step 150, may identify drivers/metrics for the business by detecting cause-and-effect relationships as shown in FIG. 6(a). At step 150, the method 100 retrieve plurality of direct and nested industry specific performance drivers/metrics with the assistance of artificial intelligence module 260. Further, the plurality of direct and nested industry specific performance drivers/metrics may be filtered as per the industry requirement. Further, the filtered direct and nested industry specific performance drivers/metrics may be structured around the business, as shown in FIG. 6(b). FIG. 6(b) may show the filtered direct and nested industry specific performance drivers/metrics structured around the business for a specific industry. However, without departing from the scope of the present disclosure, FIG. 6(b) may vary from business to business. Furthermore, at step 150, the method may estimate the effect of the filtered direct and nested industry specific performance drivers/metrics on the business. The utilization of predictive algorithms, augmented with causal inference where needed, is pivotal for discerning business health drivers, proactively anticipating internal and external shifts (including departmental or organizational-level changes and market shifts), identifying potential risks, and dynamically adapting strategies to maintain resilience and seize opportunities in the ever-evolving business landscape.

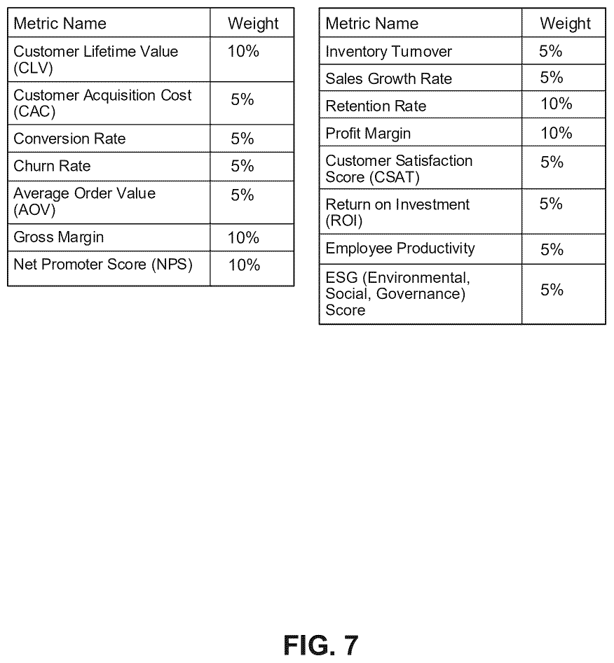

Referring now to FIG. 7, illustrating model development in the method 100 is shown, in accordance with an exemplary embodiment of the present disclosure. FIG. 7 will now be explained in conjunction with FIGS. 1 to 5(b). The computer-implemented method 100 may develop a mathematical model having an equation (shown below) with a plurality of direct and nested industry specific performance drivers/metrics with a static/dynamic driver/metric weight. The nested industry specific performance drivers/metrics are shown in table of FIG. 7. Using these weights, the method 100 may calculate the BHI as follows:

$$Business Health Index ( B H I ) = ( CLV \times 0.1 ) + ( CAC \times 0.05 ) + ( Conversion Rate \times 0.05 ) + ( Churn Rate \times - 0.05 ) + ( AOV \times 0.05 ) + ( Gross Margin \times 0.1 ) + ( NPS \times 0.1 ) + ( Inventory Turnover \times 0.05 ) + ( Sales Growth Rate \times 0.1 ) + ( Retention Rate \times 0.1 ) + ( Profit Margin \times 0.1 ) + ( CSAT \times 0.05 ) + ( ROI \times 0.05 ) + ( Employee Productivity \times 0.05 )$$

However, there may be other nested industry specific performance drivers/metrics without departing from the scope of the present disclosure. In one embodiment, the relevant nested industry specific performance drivers/metrics may be fetched by the artificial intelligence module 260 based on the industry type. In one another embodiment, the user/business may add relevant nested industry specific performance drivers/metrics manually. The computer-implemented method 100 may forecast each performance driver/metric involved in business by utilizing historical and real-time data. Further, in one embodiment of the present disclosure, the computer-implemented method 100 may automate future steps of the business based on past user actions aimed at improving the performance drivers/metrics to optimize the BHI of the business.

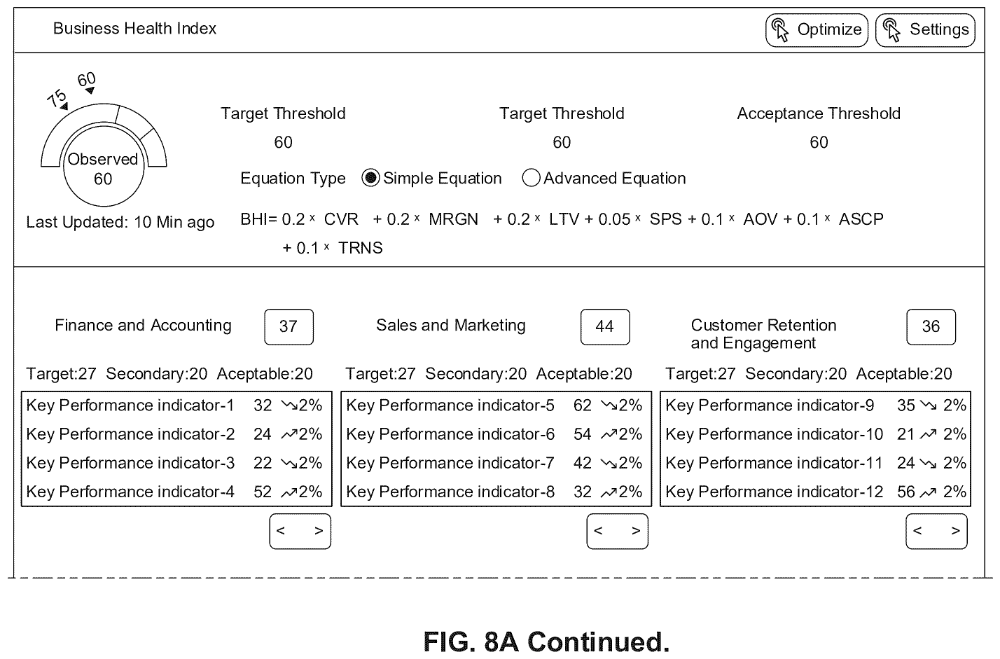

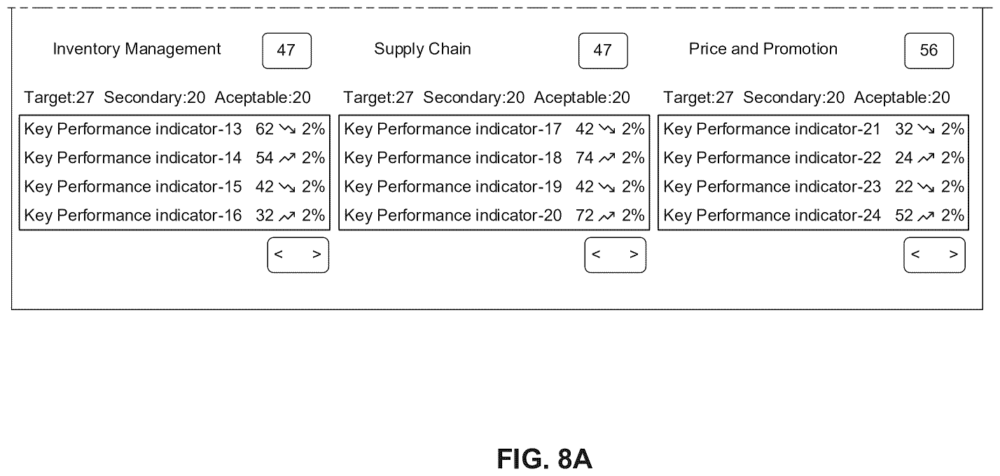

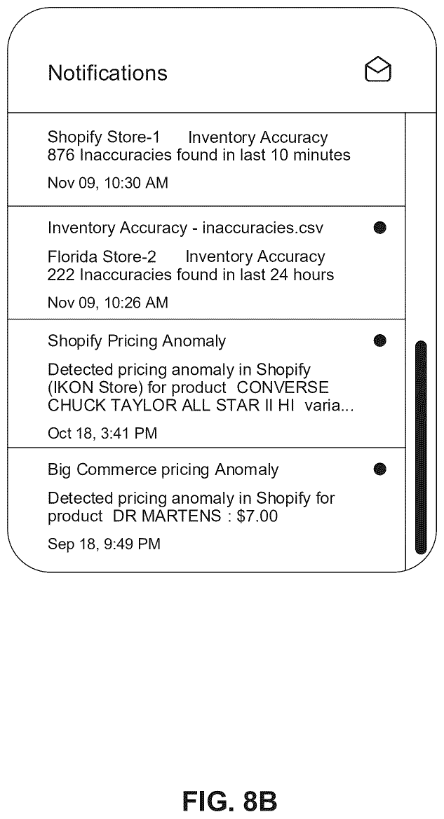

Referring now to FIG. 8(a) and FIG. 8(b), diagrams of a business optimization module in the method 100 is shown, in accordance with an exemplary embodiment of the present disclosure. FIG. 8(a) and FIG. 8(b) will now be explained in conjunction with FIGS. 1 to 6(b). The diagram shows a set of interfaces enabling a user to define and utilize industry-specific drivers/metrics with a static/dynamic driver/metric weight. The interface may show a plurality of parameters such as BHI, the equation with direct and nested industry specific performance drivers/metrics with a static/dynamic driver/metric weight and the like. Further, FIG. 8(b) shows the interface showing notifications generated by the method 100, the notifications generated by the method 100 may notify inaccuracies and anomalies in the business. However without departing from the scope of the present disclosure, the method 100 may also generate notifications for other purposes.

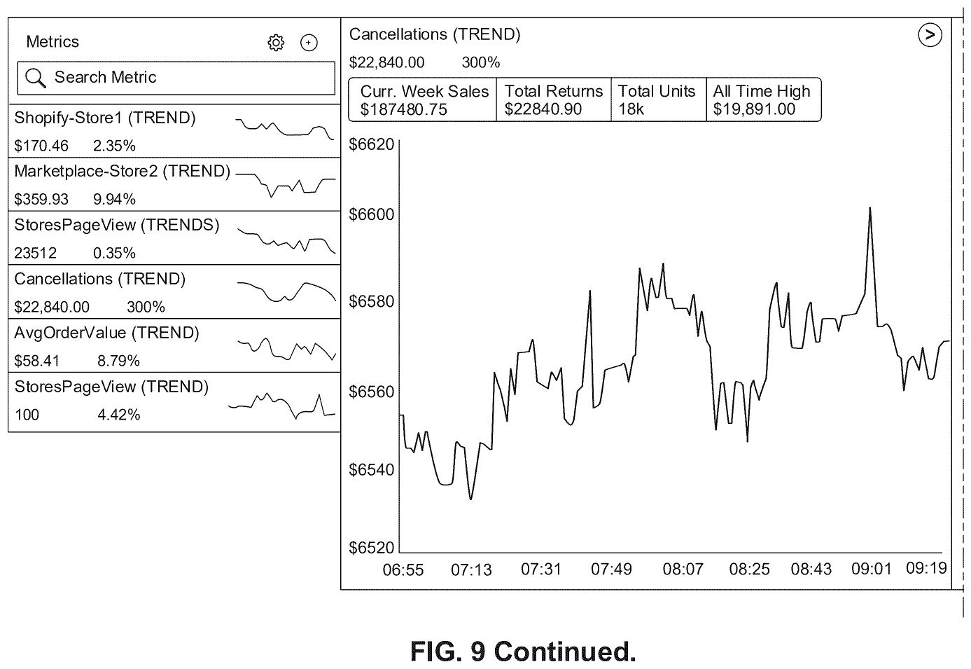

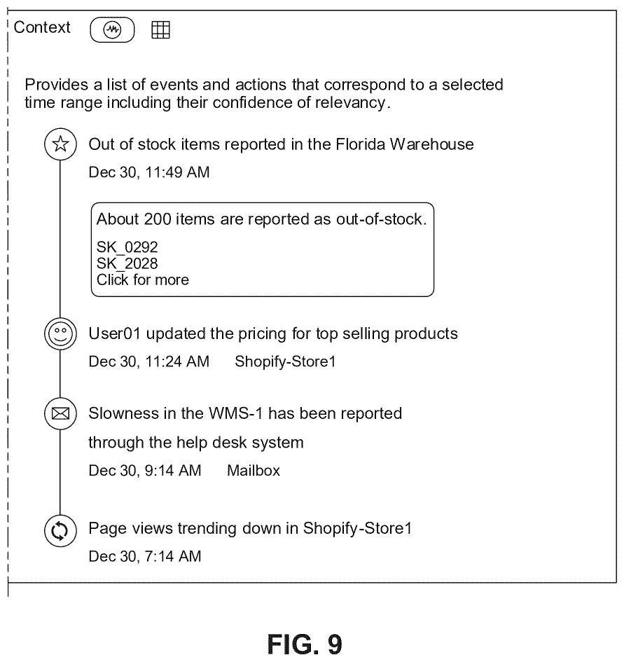

Referring now to FIG. 9, a diagram for performing root cause analysis to identify underlying causes that influence the business in the method 100 is shown, in accordance with an exemplary embodiment of the present disclosure. FIG. 9 will now be explained in conjunction with FIGS. 1 to 8(b). The diagram shows an exemplary scenario of order cancellations via an e-commerce platform or business online store/platform. The method 100, at step 180 may perform root cause analysis to identify underlying causes that influence the cancellation of the orders. For example, the method 100 at step 180 after analysis shows causes such as store page views trending down, decrease in store view, etc. This step 180 for root cause analysis to identify underlying causes that influence the business may further assist the business to by providing a list of events and actions to take necessary steps to optimize the BHI of the business. The method 100 may conduct root cause analysis to identify vulnerabilities and implementing proactive measures to mitigate risks, thereby ensuring the sustained viability and longevity of the business.

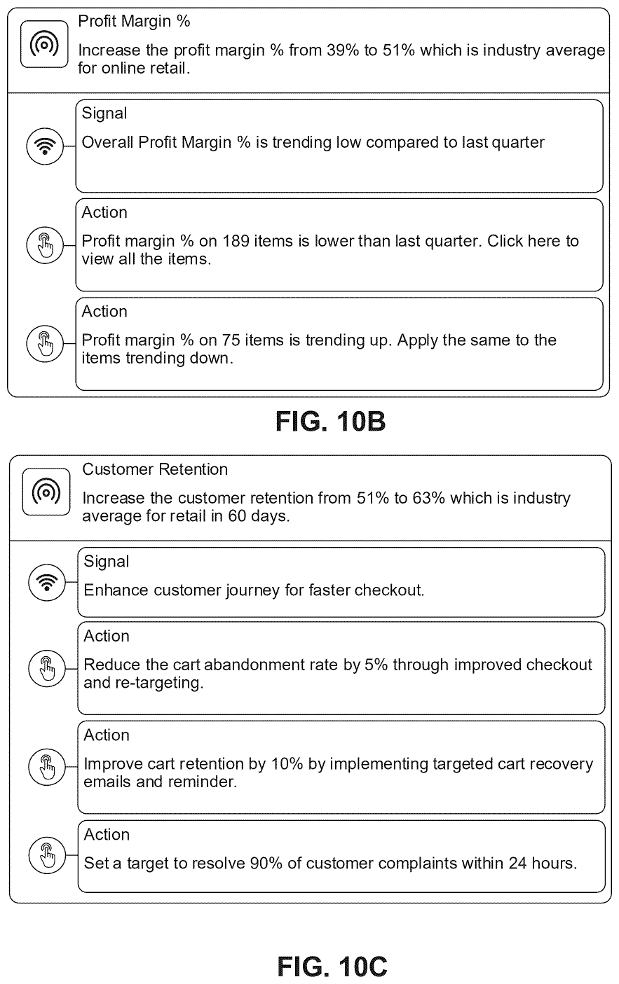

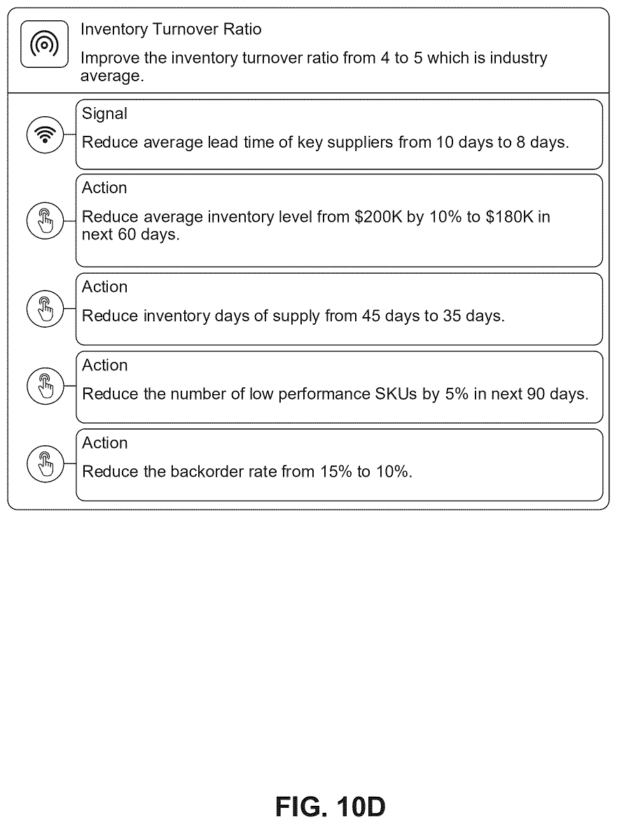

Referring now to FIGS. 10(a), (b), (c) and (d), block diagrams illustrating presentation of notifications to a user/business on a set of interfaces in the method 100 is shown, in accordance with an exemplary embodiment of the present disclosure. FIGS. 10(a) to 10(d), will now be explained in conjunction with FIGS. 1 to 9. FIG. 10(a) shows an interface showing industry-specific drivers/metrics with a static/dynamic driver/metric weight. The interface may also show a plurality of parameters such as desired BHI, conversion rate and the like. Further, the interface may also show suggestions in form of signals, events, noises and actions to achieve the desired results, shown in FIGS. 10(b), 10(c) and 10(d).

In one embodiment of the present disclosure, the computer-implemented method (100) may forecast opportunities, risks, and threats of the business by analyzing past incidents to avoid repeat mistakes and present informed decisions to the business to optimize the BHI of the business.

In one embodiment of the present disclosure, the computer-implemented method 100 may integrate external knowledge comprising industry benchmarks and aggregated actions across various industries, business units, and geographical locations to optimize the BHI of the business, for example, average sales growth and customer retention rates in the retail sector.

In one embodiment of the present disclosure, the computer-implemented method 100 may integrate cross-organizational learning capabilities, detect patterns and devise accurate, actionable strategies based on collective organizational experiences to optimize the BHI of the business.

In one embodiment of the present disclosure, the computer-implemented method (100) may suggest and assign tasks based on identified business opportunities, risks, or threats, with an automated follow-up mechanism to ensure task completion and track individual performance for accountability and rewards.

In one embodiment of the present disclosure, the computer-implemented method (100) may identify and recommend rectification and perform actions to prevent data entry errors at the source, preventing mistakes and inefficiencies, and advising against actions that may negatively impact business outcomes, via a client agent.

In one embodiment of the present disclosure, the computer-implemented method (100) may facilitate internal and external industry benchmark comparisons.

The present disclosure should not be construed to be limited to the configuration of the method and system as described herein only. Various configurations of the system are possible which shall also lie within the scope of the present disclosure.

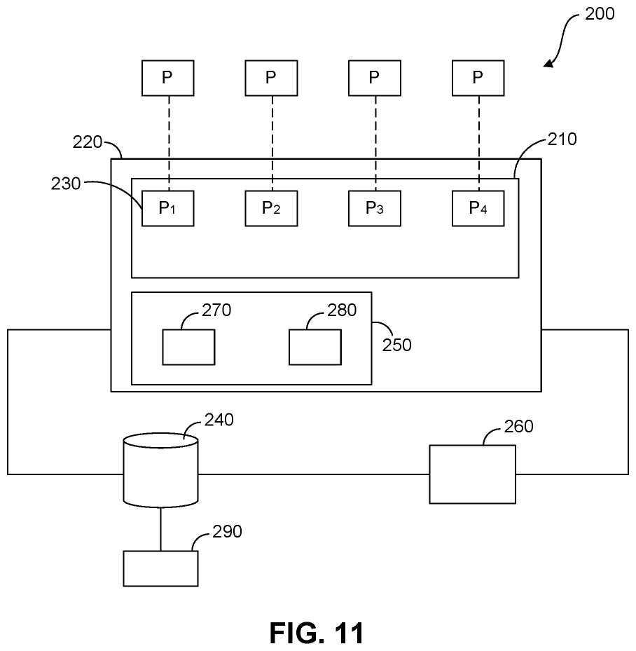

In one another aspect, a computer-implemented system 200 configured to compute, monitor, optimize and protect business health of a business in real-time may be provided. The business health may be evaluated in index form herein referred in as business health index (BHI). Referring now to FIG. 11, a block diagrams illustrating a computer-implemented system 200 to compute, monitor, optimize and protect business health of a business in real-time is shown, in accordance with an exemplary embodiment of the present disclosure. FIG. 11, will now be explained in conjunction with FIGS. 1 to 10(d). The computer-implemented system 200 may include the Data Processing Unit (DPU, mentioned earlier in the description of FIG. 1) 220, an adaptor module 210, a data center 240, a business optimization module 250 and an artificial intelligence module 260. Examples of the DPU described herein include, but are not limited to, a personal computer, a laptop, a personal digital assistant (PDA), a smart phone, a mobile computing device, and the like. The adaptor module 210 may be configured in a DPU 220, to configure a plurality of plug-ins 230 to acquire historical and real-time data. Further, the data center 240 may store the acquired historical and real-time data and coupled to the artificial intelligence module 260. The data center 240 may also acquire data from the external sources 290, for example Public data sets like Google Public data explorer, Public Social Impact Data Sets like Buzzfeed, Reddit, etc., Public Climate and Environment Data Sets like Air Quality and Pollution, US Climate Data, etc., Public Health Data Sets and Commercial data sets using the data product providers like AWS, Azure, etc. The business optimization module 250 may include an optimization algorithm to optimize the BHI. Furthermore, the artificial intelligence module 260 may organize the acquired historical and real-time data, standardize the historical and real-time data, analyse the organized and standardized data, develop a mathematical model, optimize and protect the BHI of the business.

In one embodiment of the present disclosure, the computer-implemented system 200 may include a client agent 270 configured in the business optimization module 250 to identify and recommend rectification and perform actions to prevent data entry errors at the source and prevent mistakes and inefficiencies. The client agent 270 may advise against actions that may negatively impact business outcomes.

In one embodiment of the present disclosure, the computer-implemented system 200 may include actionable buttons 280 configured in the business optimization module 250 for immediate response.

In one embodiment of the present disclosure, the computer-implemented system may include a set of interfaces enabling a user to define and utilize industry-specific drivers/metrics with a static/dynamic driver/metric weight.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, and to thereby enable others skilled in the art to best utilize the present disclosure and various embodiments with various modifications as are suited to the particular use contemplated. It is understood that various omissions and substitutions of equivalents are contemplated as circumstances may suggest or render expedient, but such omissions and substitutions are intended to cover the application or implementation without departing from the spirit or scope of the present disclosure.

What is claimed is:

1. A computer-implemented method for computing, monitoring, optimizing and protecting business health index (BHI) of a business in real-time, the computer-implemented method comprising:
receiving/acquiring historical and real-time data;
organizing the acquired historical and real-time data in a data center;
standardizing the acquired historical and real-time data in the data center;
analyzing the organized and standardized historical and real-time data in the data center;
identifying drivers/metrics for the business by detecting cause-and-effect relationships;
developing a mathematical model in real-time based on the analysis of the historical and real-time data and the identified drivers;
tracking and optimizing the BHI of the business in real-time by applying an optimization algorithm to the developed mathematical model;
performing root cause analysis to identify underlying causes that influence the business, and
presenting notification to a user/business on an interface in form of signals, events, noises and actions,
wherein the computer-implemented method uses an artificial intelligence module to organize the acquired data, standardize the acquired data, analyze the organized data, develop a mathematical model, optimize and protect the BHI of the business.

2. The computer-implemented method for computing, monitoring, optimizing and protecting business health index (BHI) of a business in real-time of claim 1, wherein the mathematical model comprises an equation having plurality of direct and nested industry specific performance drivers/metrics with a static/dynamic driver/metric weight.

3. The computer-implemented method for computing, monitoring, optimizing and protecting business health index (BHI) of a business in real-time of claim 1, wherein the method comprises: forecasting each performance driver/metric involved in business by utilizing historical and real-time data and forecasting opportunities, risks, and threats of the business by analyzing past incidents to avoid repeat mistakes and present informed decisions to the business to optimize the BHI of the business.

4. The computer-implemented method for computing, monitoring, optimizing and protecting business health index (BHI) of a business in real-time of claim 1, wherein the method comprises: automating future steps of the business based on past user actions for improving the performance drivers/metrics to optimize the BHI of the business.

5. The computer-implemented method for computing, monitoring, optimizing and protecting business health index (BHI) of a business in real-time of claim 1, wherein the method comprises: integrating external knowledge comprising industry benchmarks and aggregated actions across various industries, business units, and geographical locations, integrating cross-organizational learning capabilities, detect patterns and devise accurate, actionable strategies based on collective organizational experiences to optimize the BHI of the business.

6. The computer-implemented method for computing, monitoring, optimizing and protecting business health index (BHI) of a business in real-time of claim 1, wherein the method comprises: suggesting and assigning tasks based on identified business opportunities, risks, or threats, with an automated follow-up mechanism to ensure task completion and track individual performance for accountability and rewards.

7. The computer-implemented method for computing, monitoring, optimizing and protecting business health index (BHI) of a business in real-time of claim 1, wherein the method comprises: identifying, recommending rectifications and performing actions to prevent data entry errors at a source, mistakes and inefficiencies to guide actions that may adversely affect business outcomes.

8. The computer-implemented method for computing, monitoring and optimizing business health index (BHI) of a business in real-time of claim 1, wherein the method comprises: facilitating internal and external industry benchmark comparisons.

9. A computer-implemented system to compute, monitor, optimize and protect business health index (BHI) of a business in real-time, the computer-implemented system comprising:
a data Processing Unit, an adaptor module, said adaptor module is configured to configure a plurality of plug-ins to acquire historical and real-time data;
a data center configured to store the acquired historical and real-time data,
a business optimization module having an optimization algorithm; and
an artificial intelligence module configured to organize the acquired historical and real-time data, standardize the historical and real-time data, analyse the organized and standardized data, develop a mathematical model, optimize and protect the BHI of the business.

10. The computer-implemented system to compute, monitor, optimize and protect business health index (BHI) of a business in real-time of claim 9, comprising an edge computing client agent to identify, rectify data entry errors at their source, prevent mistakes and inefficiencies, and advise against actions that may negatively impact business outcomes.

11. The computer-implemented system to compute, monitor, optimize and protect business health index (BHI) of a business in real-time of claim 9, comprising a suite of interfaces enabling users to define or edit causal relationships, either by starting from scratch or by using pre-designed templates, facilitated through a specialized graph editor, tailored to accommodate specific needs and scenarios of the business, thereby simplifying a process of customizing causal relationships to optimize the business health index.

12. The computer-implemented system to compute, monitor, optimize and protect business health index (BHI) of a business in real-time of claim 9, comprising a set of interfaces enabling a user to define and utilize industry-specific drivers/metrics with a static/dynamic driver/metric weight.

13. The computer-implemented system to compute, monitor, optimize and protect business health index (BHI) of a business in real-time of claim 12, wherein the mathematical model comprises an equation having plurality of direct and nested industry specific performance drivers/metrics with the static/dynamic driver/metric weight.

14. The computer-implemented system to compute, monitor, optimize and protect business health index (BHI) of a business in real-time of claim 13, wherein the system forecasts each performance driver/metric involved in business by utilizing historical and real-time data, forecasts opportunities, risks, and threats of the business by analysing past incidents to avoid repeat mistakes and present informed decisions to the business to optimize the BHI of the business.

15. The computer-implemented system to compute, monitor, optimize and protect business health index (BHI) of a business in real-time of claim 14, wherein the system automates future steps of the business based on past user actions aimed at improving the performance drivers/metrics to optimize the BHI of the business.

16. The computer-implemented system to compute, monitor, optimize and protect business health index (BHI) of a business in real-time of claim 9, wherein the system integrates external knowledge comprising industry benchmarks and aggregated actions across various industries, business units, and geographical locations to optimize the BHI of the business.

17. The computer-implemented system to compute, monitor, optimize and protect business health index (BHI) of a business in real-time of claim 9, wherein the system integrates cross-organizational learning capabilities, detect patterns and devise accurate, actionable strategies based on collective organizational experiences to optimize the BHI of the business.

18. The computer-implemented system to compute, monitor, optimize and protect business health index (BHI) of a business in real-time of claim 9, wherein the system suggests and assigns tasks based on identified business opportunities, risks, or threats, with an automated follow-up mechanism to ensure task completion and track individual performance for accountability and rewards.

19. The computer-implemented system to compute, monitor, optimize and protect business health index (BHI) of a business in real-time of claim 9, wherein the system facilitates industry benchmark comparisons.

20. A computer program product embodied on a non-transitory computer readable medium, and that, when executed by a processor, cause a system to:
receive/acquire historical and real-time data;
organize an acquired historical and real-time data in a data center;
standardize the acquired historical and real-time data in the data center;
analyze the organized and standardized historical and real-time data in the data center;
identify drivers/metrics for a business by detecting cause-and-effect relationships;
develop a mathematical model in real-time based on the analysis of the historical and real-time data and the identified drivers;
track and optimize a business health index (BHI) of the business in real-time by applying an optimization algorithm to the developed mathematical model;
perform root cause analysis to identify underlying causes that influence the business, and
present notification to a user/business on an interface in form of signals, events, noises and actions.
